(19) United States
(12) Patent Application Publication
(10) Pub. No.: US 2024/0046737 A1
(43) Pub. Date: Feb. 8, 2024

(54) GAMING DEVICE WITH AWARD WHEELS

(71) Applicant: Aristocrat Technologies Australia Pty Limited, North Ryde (AU)

(72) Inventors: Antoon Visser, Coogee (AU); Karen Kendall, Toongabbie (AU); James Loader, Springfield (AU); Joshua Matos, Cordeaux Heights (AU); Luke Ireland, Denistone (AU)

(21) Appl. No.: 18/148,843

(22) Filed: Dec. 30, 2022

(30) Foreign Application Priority Data
Aug. 5, 2022 (AU) 2022211903

(51) Int. Cl. G07F 17/32; G07F 17/34

(52) U.S. Cl. CPC G07F 17/3211; G07F 17/34; G07F 17/3267; G07F 17/329

(57) ABSTRACT

Determining an outcome includes displaying at least one award wheel, the award wheel comprising a plurality of layers, each layer displaying a respective one of a plurality of different sets of wheel awards, selecting, using a random number generator, symbols from the reel strips for display at a plurality of symbol positions, and controlling the display to display the selected symbols at the symbol positions. Upon the selected symbols including at least a threshold number of a defined symbol, a set of wheel awards to be used from the plurality of different sets of wheel awards displayed on the layers of the award wheel are determined based on the number of the at least a threshold number of defined symbols, and a wheel award is selected from the determined set of wheel awards. The outcome is based on the selected wheel award and any winning outcomes.

### FIELD OF THE INVENTION

The present application relates to a gaming device, a method of operating a gaming device and a system with award wheels.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

### SUMMARY

There is disclosed a gaming device, a method of operating a gaming device and a system with multi-layered prize award wheels. Each layer of the prize award wheel has a different set of awards. The prize award wheels are triggered by the selection of a threshold number of defined symbols during a game instance, such as a feature game instance. In a disclosed embodiment, the number of defined symbols determines which of the layers is used in a random award determination conducted by the processor and the processor visually modifies the multi-layered award wheel to show a modified wheel having prize awards of the determined layer before spinning the wheel to a stopping position at which the randomly determined prize is indicated.

An example embodiment describes a gaming device comprising a display, a random number generator, at least one input mechanism, a processor, and a memory storing (i) reel data defining a plurality of reel strips, and (ii) instructions. When the instructions are executed by the processor, they cause the processor to control the display to display at least one award wheel, the award wheel comprising a plurality of layers, each layer displaying a respective one of a plurality of different sets of wheel awards, select, using the random number generator, symbols from the reel strips for display at a plurality of symbol positions in response to receipt of a wager via the at least one input mechanism, control the display to display the selected symbols at the symbol positions, upon the selected symbols including at least a threshold number of a defined symbol, make a wheel award from the award wheel by (i) determining a set of wheel awards to be used from the plurality of different sets of wheel awards displayed on the layers of the award wheel based on the number of the at least a threshold number of defined symbols, and (ii) selecting, using the random number generator, a wheel award from the determined set of wheel awards, evaluate the selected symbols for winning outcomes, and make an award based on the selected wheel award and any winning outcomes.

Another example embodiment describes a method of operating a gaming device comprising a display, a random number generator, at least one input mechanism, a processor, and a memory storing reel data defining a plurality of reel strips. The method comprises controlling the display to display at least one award wheel, the award wheel comprising a plurality of layers, each layer displaying a respective one of a plurality of different sets of wheel awards, selecting, using the random number generator, symbols from the reel strips for display at a plurality of symbol positions in response to receipt of a wager via the at least one input mechanism, controlling the display to display the selected symbols at the symbol positions, upon the selected symbols including at least a threshold number of a defined symbol, making a wheel award from the award wheel by (i) determining a set of wheel awards to be used from the plurality of different sets of wheel awards displayed on the layers of the award wheel based on the number of the at least a threshold number of defined symbols, and (ii) selecting, using the random number generator, a wheel award from the determined set of wheel awards, evaluating the selected symbols for winning outcomes, and making an award based on the selected wheel award and any winning outcomes

Another example embodiment describes a system comprising at least one display, a random number generator, at least one input mechanism, one or more processors, and a memory storing (i) reel data defining a plurality of reel strips, and (ii) instructions. When executed by the one or more processors, cause the one or more processors to control the at least one display to display at least one award wheel, the award wheel comprising a plurality of layers, each layer displaying a respective one of a plurality of different sets of wheel awards, select, using the random number generator, symbols from the reel strips for display at a plurality of symbol positions in response to receipt of a wager via the at least one input mechanism, control the at least one display to display the selected symbols at the symbol positions, upon the selected symbols including at least a threshold number of a defined symbol, make a wheel award from the award wheel by (i) determining a set of wheel awards to be used from the plurality of different sets of wheel awards displayed on the layers of the award wheel based on the number of the at least a threshold number of defined symbols, and (ii) selecting, using the random number generator, a wheel award from the determined set of wheel awards, evaluate the selected symbols for winning outcomes, and make an award based on the selected wheel award and any winning outcomes.

Another example embodiment describes a method of controlling a gaming device interface comprising a display and at least one input mechanism. The method comprises controlling the display to visually display an award wheel, the award wheel comprising a plurality of layers, each layer displaying a respective one of a plurality of different sets of wheel awards, controlling the display to visually display a random selection of symbols from reel strips at a plurality of symbol positions in response to receipt of a wager via the at least one input mechanism, upon a trigger condition being met in respect to the award wheel, controlling the display to modify the visual display of the award wheel to show a single set of wheel awards of the plurality of different sets of wheel awards displayed on the layers of the award wheel, and controlling the display to show the modified award wheel spinning to a stopped configuration relative to an award indicator that indicates an awarded wheel prize, controlling the display to visually display an evaluation of the selected symbols for winning outcomes, and controlling the display to visually display making an award based on the awarded wheel prize and any winning outcomes

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIG. 5A and 5B show a flow chart of a method of operating a gaming device.

FIGS. 6 to 18 are example screen displays resulting from operating the gaming device.

### DETAILED DESCRIPTION

Embodiments described herein are generally related to a multi-layered prize award wheel. In particular, embodiments described here in are directed to a multi-layered prize award wheel where each layer of the wheel has a different set of awards. Based on a number of symbols in the outcome of a game instance, one of the layers will be selected. From that layer, a wheel outcome is selected using a random number generator.

Embodiments described herein provide a technical improvement by providing an additional component which affects the result of a game. The use of the multi-layered prize wheel adds additional variability to the outcome of a game without requiring additional reel strips to be added. As such, by using the combination of the reel strips and the multilayered prize award wheel, the number of permutations of game outcomes increases exponentially without necessitating in the exponential increase in reel strip data or the like.

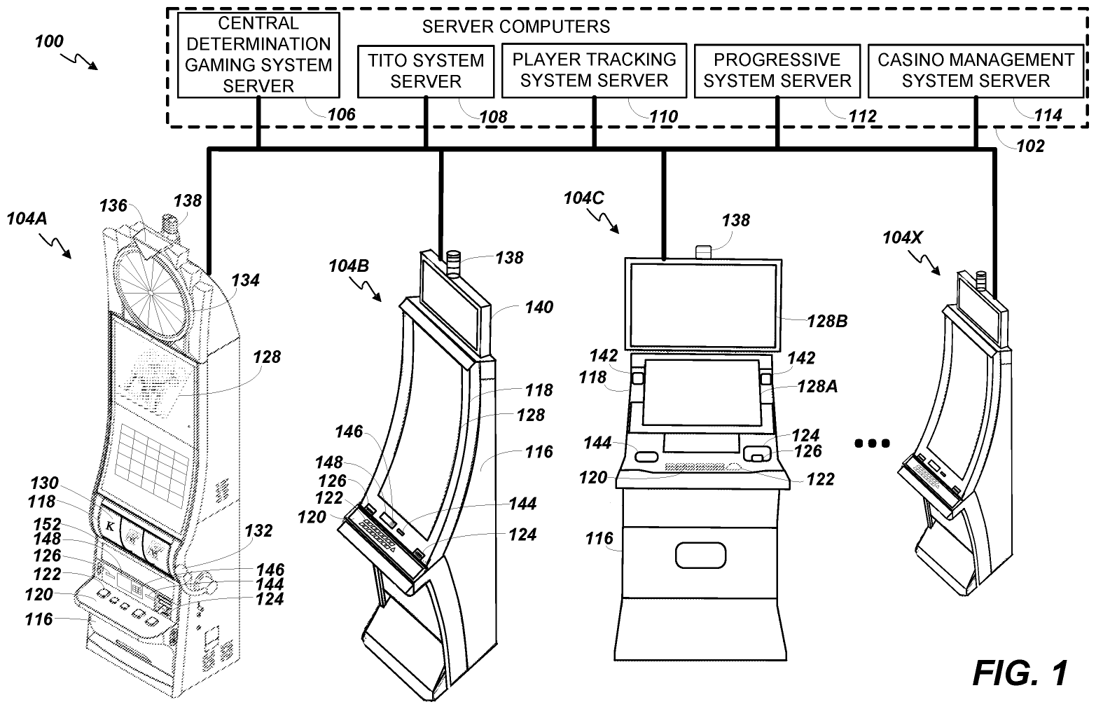

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

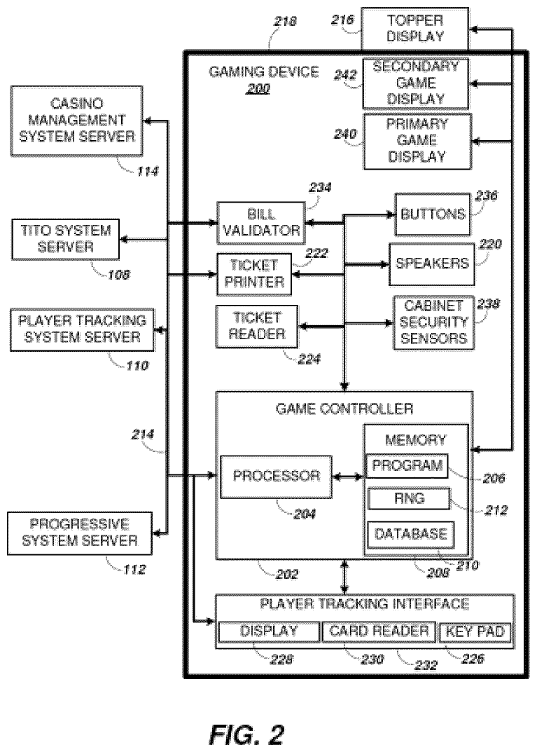

Many or all the above described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc. FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2 illustrates that game controller 202 includes a single processor 204, game controller 202 is not limited to this representation and instead can include multiple processors 204 (e.g., two or more processors).

The memory 208 may include one or more mass storage devices or media that are housed within gaming device 200. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2 illustrates that game controller 202 includes a single memory 208, game controller 202 could include multiple memories 208 for storing program instructions and/or data.

Memory 208 can store one or more game programs 206 that provide program instructions, or computer readable code, and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

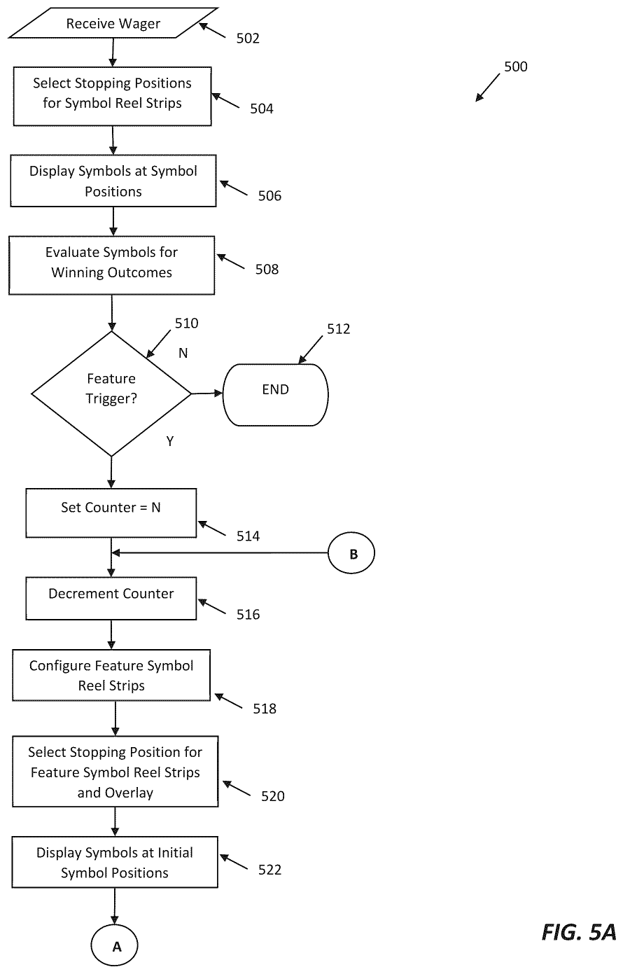

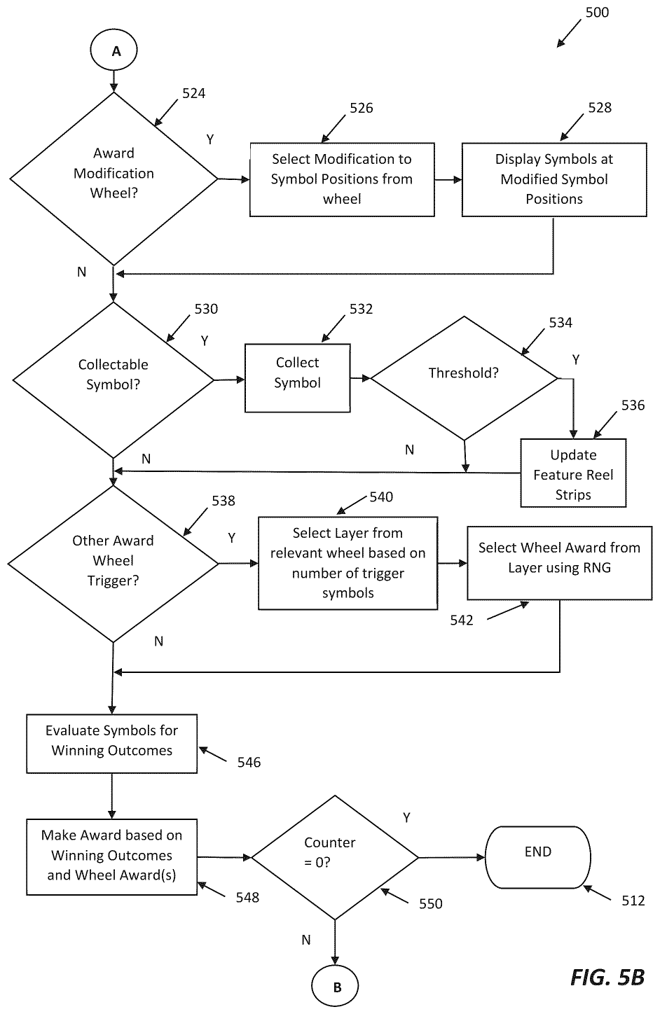

FIG. 5 is a flow chart of an example embodiment of a method 500 of operating a gaming device 200. At step 502, the processor 204 receives a wager input by a player using an input mechanism, for example, a virtual button deck—that is a touch screen display that displays virtual buttons that the player can “press” by touching the virtual button deck where one of a plurality of buttons is displayed. In other examples, a physical button deck may be employed or a hybrid button deck having a mixture of virtual and physical buttons. The buttons may include a play button which allows the player to place the same wager placed in the previous game.

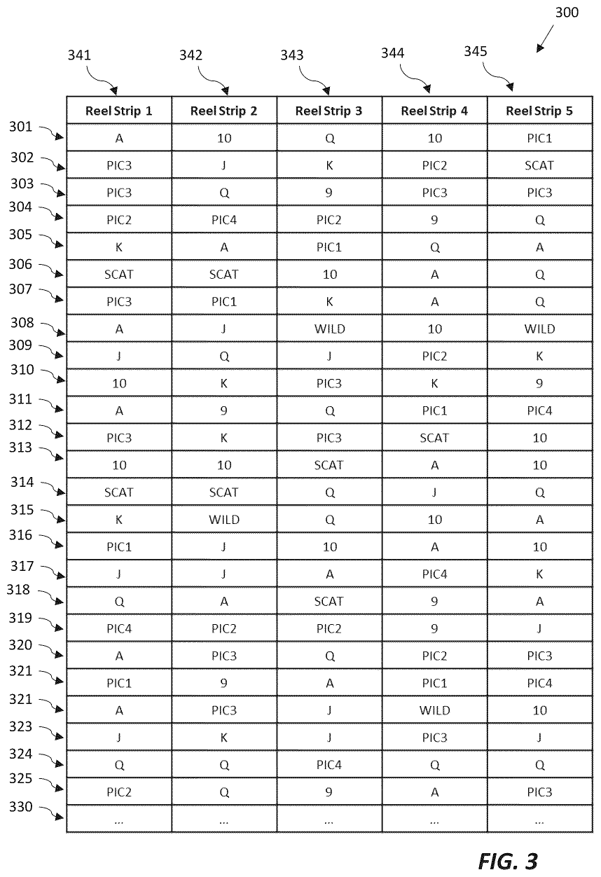

At step 504, the processor selects symbols by selecting stopping positions for a plurality of reel strips stored in one or more reel strip data structures stored in memory 208. FIG. 3 illustrates an example reel strip data structure having a set 300 of five reel strips 341, 342, 343, 344, 345. In the example, for illustrative purposes, twenty-five reel strip positions 301-325 are shown for each reel strip 341-345. In this example, each reel strip position of each reel has a symbol. In other examples, there may be one or more blank symbol positions. For example, a “Wild” symbol occupies the eight reel strip position 308 of the third reel strip 343. The symbols shown on the reel strips 341-345 are generally indicative of symbols that may be employed in the embodiments, however, other reels strips to those illustrated in FIG. 3 can be used. Symbol position 330 indicates that the reel strips 341-345 will typically have more symbols than illustrated. For example, the reel strips 341-345 could have between 30 and 100 reel strip positions with the last reel strip position of a respective reel strip being treated as contiguous with the first reel strip position 301 as would be the case with a mechanical reel. The actual lengths of the game reel strips depend on factors such as the lengths of the stacks, the number of wild symbols (in general, the more wilds there are, the longer the reel strip needs to be to maintain the target RTP), and volatility (in general, the higher the prize value is, the longer the reel strip needs to be to lower the hit rate to maintain the target RTP). In some examples, the reel strips associated with different columns may be of different lengths to one another.

As shown in FIG. 3, in this example, each of the reel strips 341-345 has scatter symbols as indicated by the symbol “SCAT” (see, for example, the sixth position 306 of the first and second reel strips 341, 342. Scatter symbols are evaluated independently of the position at which they are selected by the processor. While this example shows scatter symbols on each reel strip other examples may only have scatter symbols on some of the reel strips. For example, in a case where the scatter symbols also act as wild symbols, there may be no scatter symbols on a first reel strip.

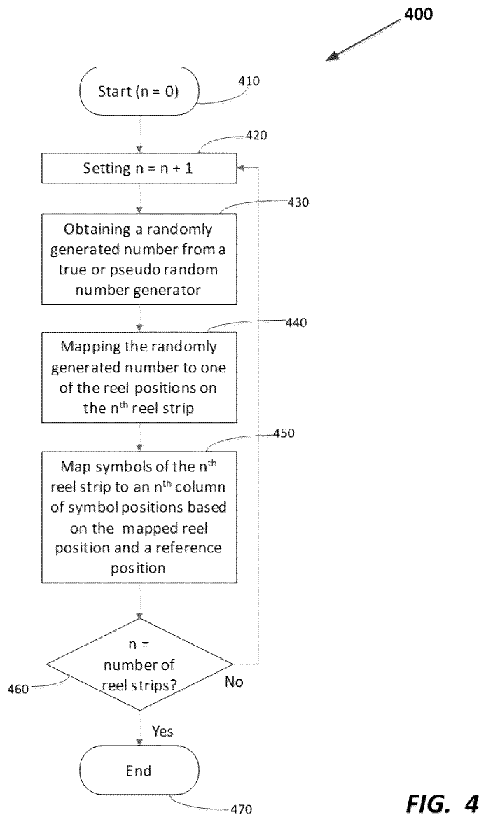

FIG. 4 is a flow chart of an example method 400 carried out by the processor 204 to select symbols from reel strips 341-345 at step 504. At step 410, the processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table in memory 208. In one example, the ranges are each the same size so that each of the reel strip positions has the same chance of been selected. In other examples, the ranges may be arranged to weight the relative chances of selecting specific reel strip positions.

At step 450, the processor 204 maps symbols of the nth reel strip to and nth column of symbol display positions based on the mapped reel position and a reference position. In an example, the reference position is the bottom position of the symbol positions of each column of symbol positions. In this example, the selected reel position or “stopping position” (and hence the symbol at this position) is mapped to the bottom symbol position of the column. Referring to the example reel strips of FIG. 3, if the value returned by the RNG 212 is mapped to reel position 313 when four symbols are being selected for the first column of symbol positions, then for the first reel strip 341, “10” is mapped to a bottom symbol position and the three symbols immediately above it (here “PIC3”, “A”, and “10”) are mapped to the symbol positions above the symbol position while preserving the reel strip order of the first reel strip. The number of symbols mapped can be changed in examples where there are different numbers of symbol positions in a column

At step 460, the processor 460 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470. It will be appreciated that in other examples, there may be different numbers of symbol positions. Indeed, in in the feature game instances described below, the number of active symbol positions in the second to fourth columns can vary between four and seven symbol positions and hence the mapping depends on how many are currently active in a specific column.

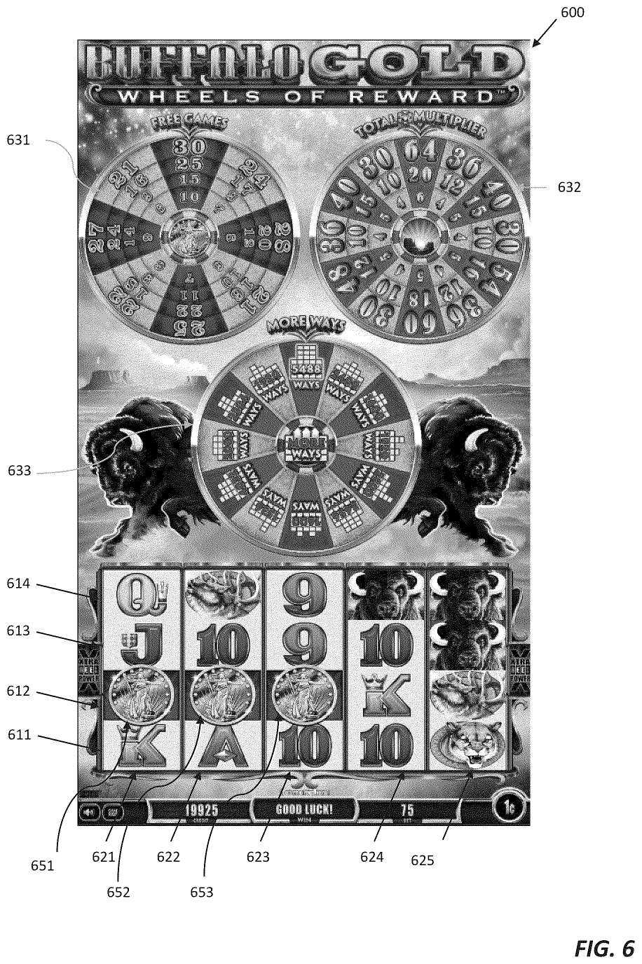

After the symbols of all reel strips have been mapped to symbol position, at step 506, the processor 204 controls display 240 to display them at the symbol positions, in this example by controlling the display to animate the reel strips as spinning to the selected stopping positions. For example, as shown in the example screen display 600 of FIG. 6, symbols of five reel strips are mapped to five columns 621-625 of four symbol positions such that there are also four rows 611-614 of symbol positions.

Example screen display 600 also shows three award wheels 631-633 that are used in a feature game when it is triggered. These are the Free Games Wheel 631, the Multiplier Wheel 632 and the More Ways Wheel 633.

At step 508, the processor 204 evaluates the selected symbols, in this example, based on a ways to win evaluation and a pay table stored in memory 208. In this example, there are up to 4₅=1024 ways to win depending on the wager made using the input mechanism. Any winning amounts are added by processor 204 to either a win meter or credit meter stored in memory 208.

At step 510, the processor 204 determines whether a feature trigger condition is met. In this example, the trigger condition is that the displayed symbols include at least a threshold number of scatter (SCAT) symbols. In this example, the scatter symbols take the form of COIN symbols and the threshold number is three symbols. In this respect, FIG. 6 shows an example where three COIN symbols 651-653 have been selected by processor 204 such that at step 510, the processor determines that the feature trigger condition is met and awards the feature game. In an example 3, 4 or 5 COIN symbols trigger 8, 15 and 20 free games respectively.

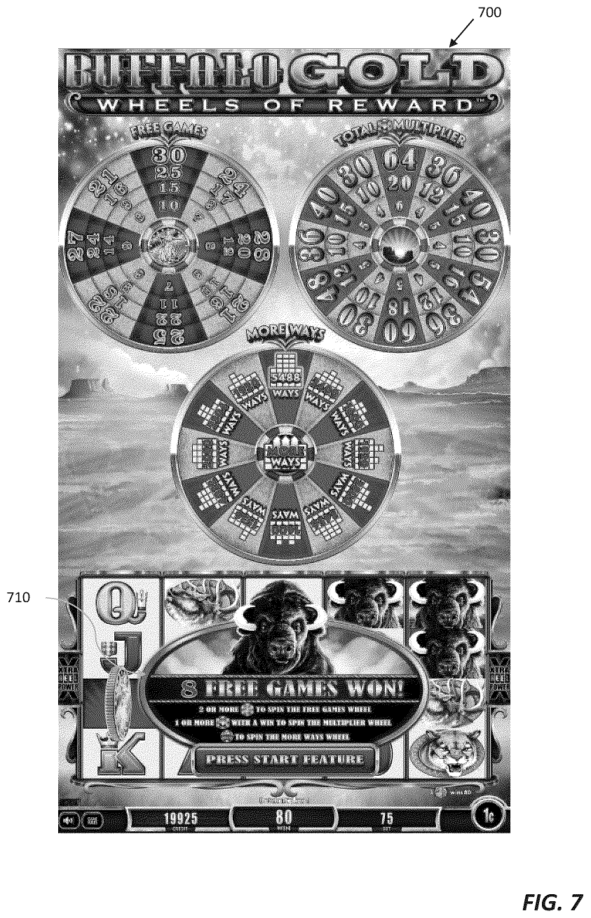

FIG. 7 is an example screen display 700 when the feature game is awarded. The processor 204 controls the display to show game message 710 “8 Free Games Won! 2 or More [special SCAT symbols] to Spin the Free Games Wheel. 1 or More [special WILD symbols] to Spin the Multiplier Wheel. [OVERLAY symbol] to Spin the More Ways Wheel”. This game message 710 indicates the number of free games initially awarded by processor 204 for the feature game and gives an indication of events that can occur during the feature game in relation to the award wheels 631-633.

At step 514, processor 204 sets a counter to the number of awarded games, in this example to eight.

Processor 204 then initiates the first free game instance. In this respect, at step 516, processor 204 decrements counter by one to reflect that the initiation of a free game instance.

In this example, at step 518, the processor 204 configures the feature symbol reel strips for the current game instance. The feature reel strips are similar to those used in the base game. However, some of the BUFFALO (PIC1) symbols are changed to GOLD BUFFALO (PIC1) symbols, to indicate that they can be collected during the feature game. In addition, in each game instance, all SCAT symbols may be replaced by SPECIAL SCAT and all WILD symbols on a chosen reel strip (or reel strips) associated with the second 622, third 623 and fourth 624 columns of symbol positions will be replaced by SPECIAL WILD. In this respect, at step 518, the processor conducts at least one random determination using a weight table stored in memory and RNG 212 to determine whether these changes will be made to the reel strips in a current game instance.

At step 520, the processor 204 selects symbols from the feature reels strips using the method described in relation to FIG. 4. In addition, the processor 204 selects a stopping position for an overlay reel strip that, in this example, comprises a number of symbol positions which are blank (so that the underlying symbol of the feature reel strip can be seen) and one or more symbol positions having a defined symbol in the form of a SPECIAL OVERLAY symbol which will be superimposed on the underlying feature reel strip. In this example, processor 204 selects the stopping position of the overlay reel strip by first selecting a column to which the overlay reel strip will correspond in a current game instance using a weighted table stored in memory 208 and RNG 212 and then using the same stopping position as selected for the feature reel strip for that column. For example, if the processor 204 selects the third column to have the overlay reel strip and selects the 20^{th} stopping position for the third reel strip, processor 204 sets the 20^{th} stopping position as the stopping position for the overlay reel strip. In other examples, processor 204 may independently determine the stopping position for the overlay reel strip using the process of FIG. 4.

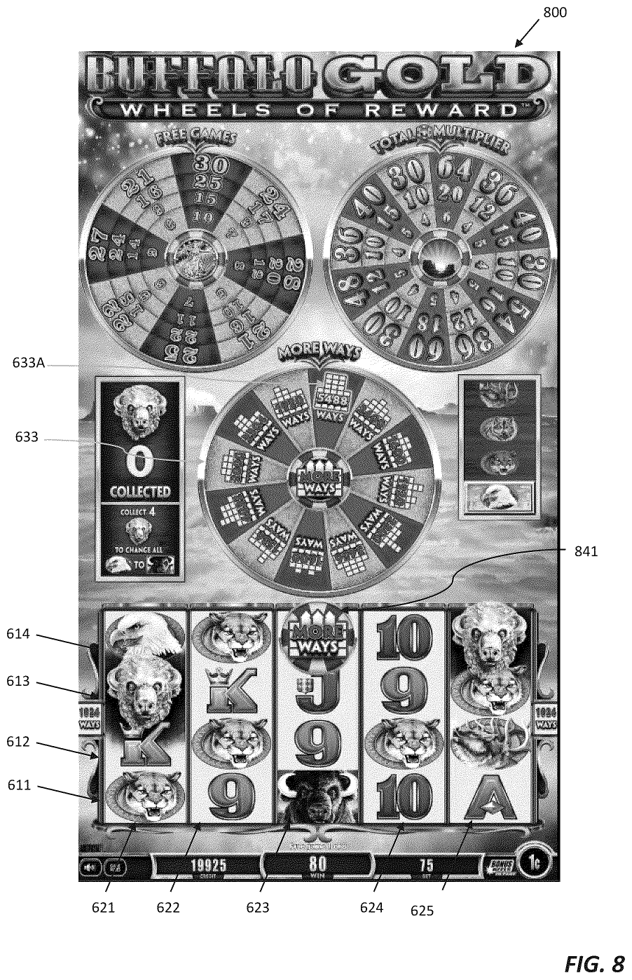

At step 522, the processor 204 controls the display 240 to display the selected symbols based on the stopping positions at an initial set of symbol positions. An example of such a display is shown in FIG. 8, where symbols are displayed at twenty symbol positions arranged in five columns 621-625 and four rows 611-614. FIG. 8 shows an example, where a SPECIAL OVERLAY (“MORE WAYS”) symbol 841 has been displayed as a result of the processor 204 selecting the overlay reel strip to be associated with the third column and the set stopping position for the overlay reel strip resulting in the MORE WAYS symbol 641 being displayed.

At step 524, the processor 204 determines whether to award the symbol position modification award wheel (the “More Ways” wheel) based on whether the designated symbol from the overlay reel is displayed, here the MORE WAYS symbol. Accordingly, the example shown in FIG. 8 meets the condition for the processor 204 awarding the More Ways wheel. Upon the condition being met, processor 204 controls the display to animate the MORE WAYS symbol moving to the More Ways award wheel 633 such that it is removed from the displayed symbols revealing the underlying symbol selected from the feature reel strips.

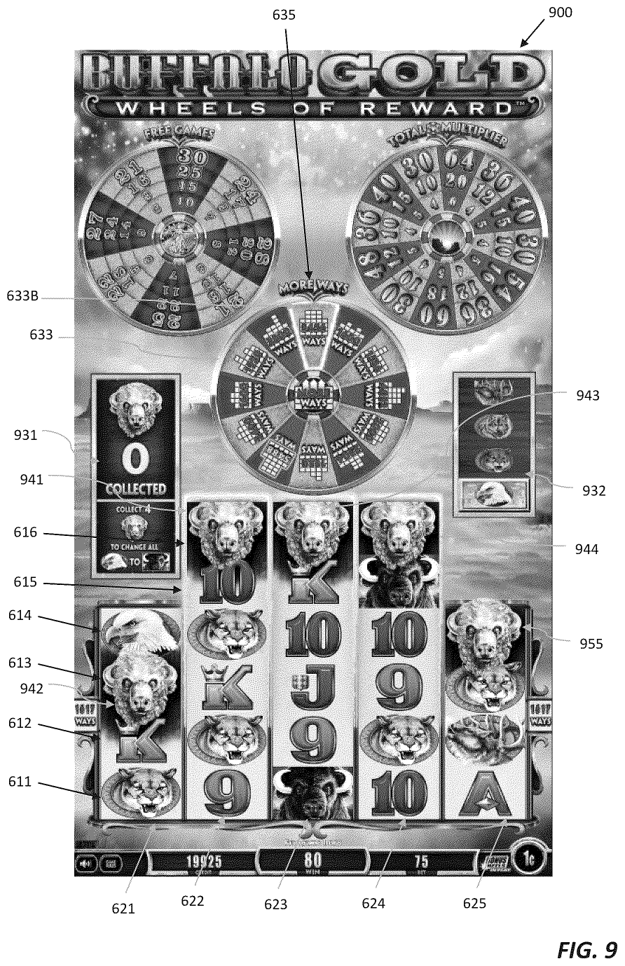

At step 526, the processor 204 selects one of the modifications to the symbol positions from the twelve options displayed on the More Ways award wheel 633. In this respect, as the processor 204 evaluates winning outcomes using a ways to win evaluation, changing the number of symbol positions at which the processor 204 display symbols also changes the number of ways to win. For example, if option 633A is selected, three symbol positions are added to the second to fourth columns and there are then 4×7×7×7×4=5488 ways to win. Accordingly, each of the options corresponds to a different number of ways to win. In order, to select from the options at step 526, the processor 204 uses a weighted table stored in memory 208 and RNG 212. Once the processor 204, selects one of the options, processor 204 controls display of the symbol position modification award wheel 633 spinning to a stopping position relative to an award indicator 635 as shown in the example screen display 900 of FIG. 9. In this respect, FIG. 9 shows an example where processor 204 has selected a modification option 633B in which two symbol positions are added to each of the second to fourth columns so that there are 4×6×6×6×4=3456 ways to win. According to one or more embodiments, the processor 204 may select a wheel award from a set of wheel awards associated with a particular award wheel. The sets of wheel awards may be stored in one or more wheel award data structure, which stores, in memory, one or more sets of wheel awards. Each set of wheel awards may be associated with a particular wheel.

At step 528, processor 204 controls the display to display the modified symbol positions and symbols at each of the symbol position. This process is in effect a remapping process where the processor 204 maps symbols based on the stopping position and reference position to the modified numbers of symbol positions in each columns. In the example, of FIG. 9, this result in two additional rows of symbol position 615,616 for columns 622-624 with two additional symbols being displayed in each of those columns.

In this respect, in this example any available modification to the number of symbol positions is always made first so that symbols in the added symbol positions are taken into account in further evaluation of the selected symbols.

At step 530, the processor 204 determines whether the selected symbols include any collectable symbols, in this example the GOLD BUFFALO symbols that may be added to the reels strips as described above. Screen display 900 incorporates a counter 931 which shows a current number of collected GOLD BUFFALO symbols and game message “Collect 4 [GOLD BUFFALO symbols] to change [EAGLE symbol] to [BUFFALO symbol]” to indicate that all EAGLE symbols will be changed to BUFFALO symbols on the feature reel strips in subsequent game instances after the threshold number of 4 GOLD BUFFALO symbols is collected. Screen display 900 also contains a modifiable symbol indicator 932 which indicates that the EAGLE symbol may be changed and also that further symbols may be changed in subsequent game instances.

In the example of screen display 900, five GOLD BUFFALO symbols 941-945 are displayed so that at step 532, and hence five symbols are collected as shown by updated symbol counter 931A in example screen display 1000. Once GOLD BUFFALO symbols are collected, they are removed from display 240 by processor 204 and replaced with normal BUFFALO symbols 941A-945A. In this example, the processor 204 will determined at step 534 that the threshold (here 4) has been met and update the feature reel strips to be used in the next game instance at step 536.

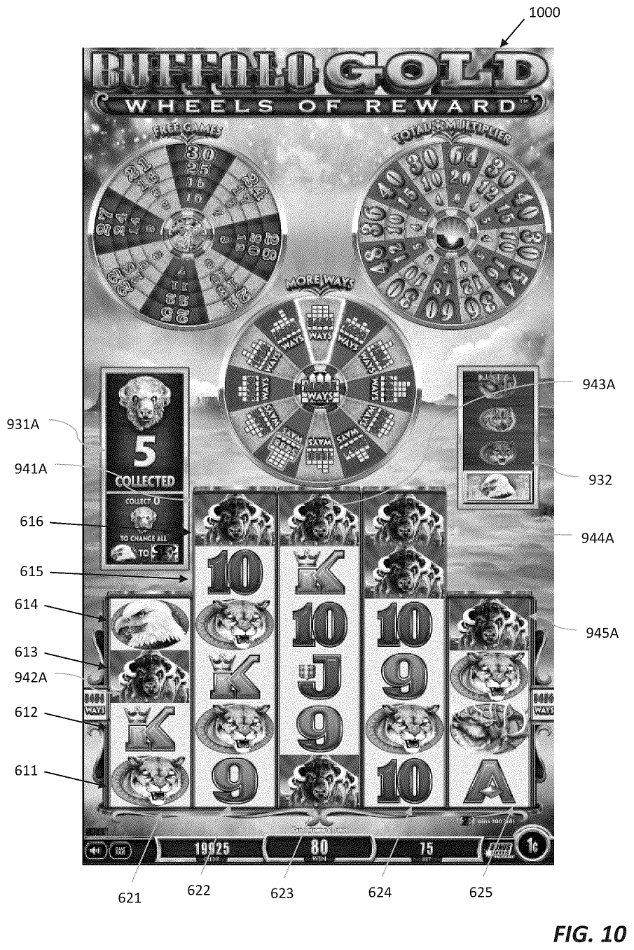

At step 538, processor 204 determines whether there is another award wheel trigger, and if not as is the case in the example screen display 1000 of FIG. 10, proceed to step 548 and make an award based on any winning outcomes and any wheel awards (in this case the wheel award is the award of additional symbol positions). Accordingly, in this example, at step 548 processor 204 determines winning outcomes based on a pay table in memory 208 and the 3456 ways to win provided by the modified display of symbol positions shown in FIG. 10. The processor 204 then adds any winning amounts to a win meter or credit meter in memory 208. In the example, the modified symbol positions apply only for the current game instance and revert to the initial number of symbol positions for the next game instance.

At step 550, the processor 204 determines whether the counter has reached zero (that is, whether all awarded game instances have been conducted) and, when the counter is zero, ends the game or, when the counter is non-zero, reverts to step 516 as indicated by connector B.

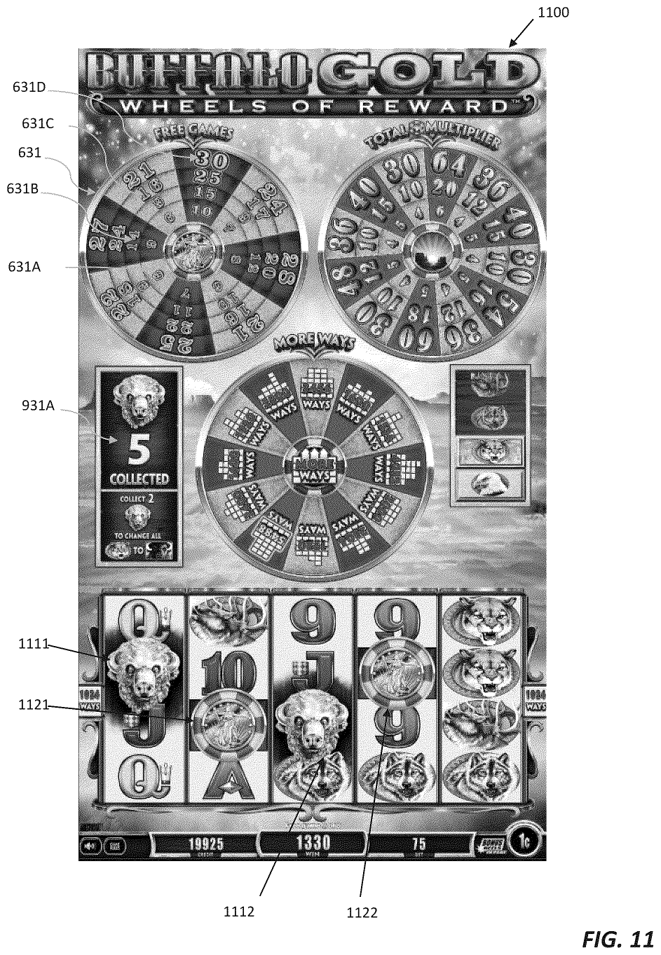

FIGS. 11 to 13 show an example of another wheel award being made at step 538 in a subsequent game instance of the awarded game instances. Processor 204 follows the same processing steps (516-524) outlined above but in this example, the symbol modification wheel is not awarded at step 524 because there is no displayed OVERLAY symbol in screen display 1100.

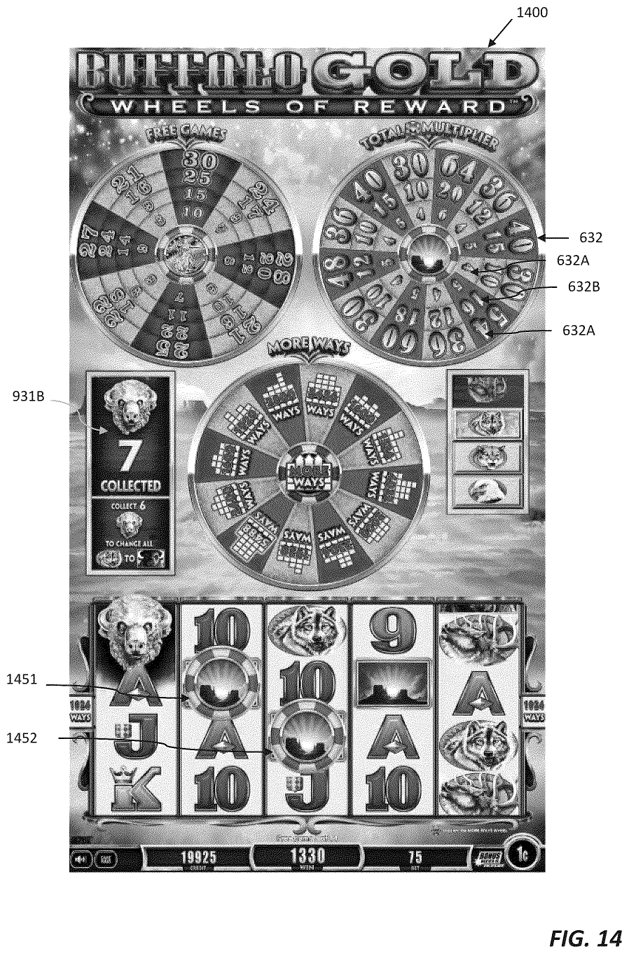

In this example, at step 530 processor 204 will make a positive determination to collect symbols because two GOLD BUFFALO symbols 1111, 1112 are displayed and the screen display 1400 of FIG. 14 shows an updated counter 931B that reflects collection of these symbols.

In screen display 1100, the selected symbols includes two SPECIAL SCAT symbols 1121,1122 which is equal to the threshold number of a defined symbol (here the SPECIAL SCAT symbol) required to initiate an award from the Free Games Wheel 631. Accordingly, the processor 204 makes a positive determination at step 538 and proceeds to make a layer selection for the Free Games wheel 631 at step 540. In this respect, each of the four layers 631A-631D displays a set of eight different wheel awards with the sets of each layer being different. The processor 204 determines which layer is to be used (and hence which set of wheel awards are to be used) based on the number of defined symbols (assuming at least a threshold number have been selected for display). Then, at step 542 the processor 542 selects a wheel award from the determined set of wheel award using RNG 212 and a weight table stored in memory. In this example:

When 2 SPECIAL SCAT trigger Free Games wheel 631, the prizes from layer 1 (the innermost layer) 631A will be available, and one of them will be awarded.

When 3 SPECIAL SCAT trigger Free Games wheel 631, the prizes from layer 2 631B will be available, and one of them will be awarded.

When 4 SPECIAL SCAT trigger Free Games wheel 631, the prizes from layer 3 631C will be available, and one of them will be awarded.

When 5 SPECIAL SCAT trigger Free Games wheel 631, the prizes from layer 4 (the outermost layer) 631D will be available, and one of them will be awarded.

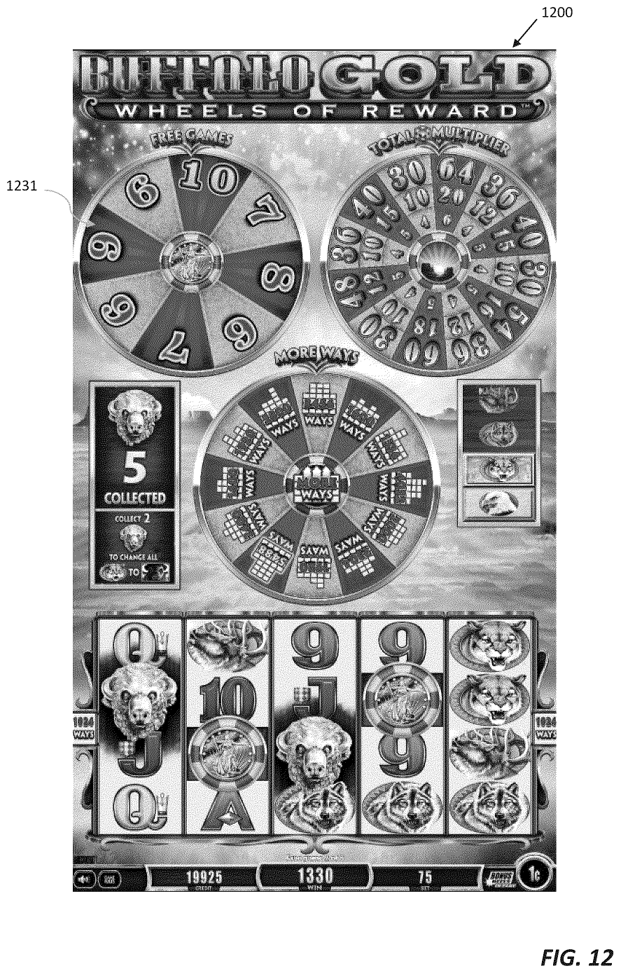

As described above, in the case of FIG. 11, 2 SPECIAL SCAT symbols are selected and accordingly, processor 204 makes the selection using RNG 212 from the prize awards associated with layer 1 631A. As part of doing so, the processor 204 modifies the visual display of Free Games award wheel to display a modified Free Games award wheel 1231 as shown in FIG. 12 in which only prizes of the selected layer are displayed (here the prizes previously displayed on the innermost layer in FIG. 11). Processor 204 then controls the display 240 to visually display an animation of the modified Frees Games award wheel spinning to a stopped configuration 1231A relative to an award indicator 1330 to indicate an awarded wheel prize. In this example, six free game instances as emphasized by game message 1320 “6 Free Games Won!).

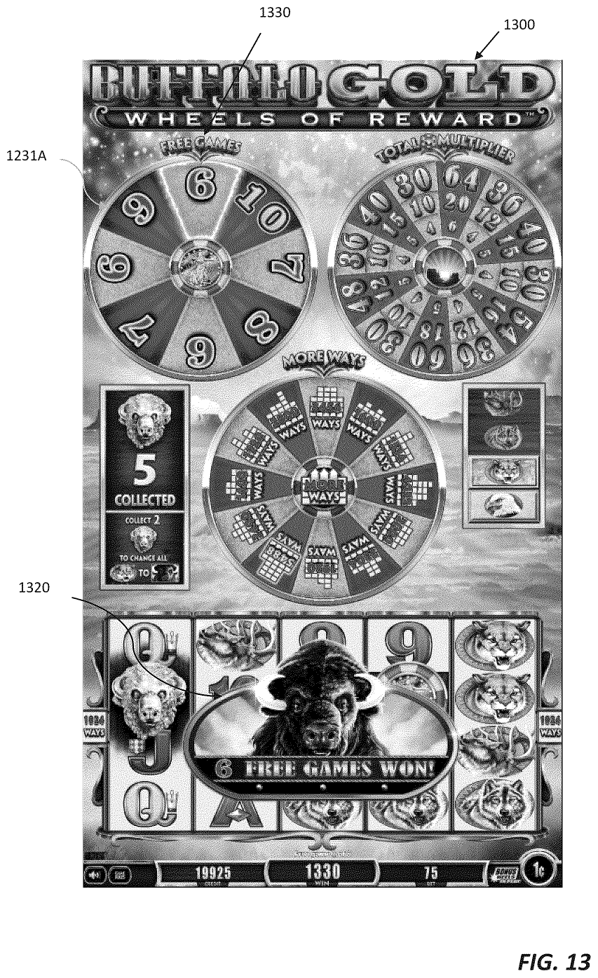

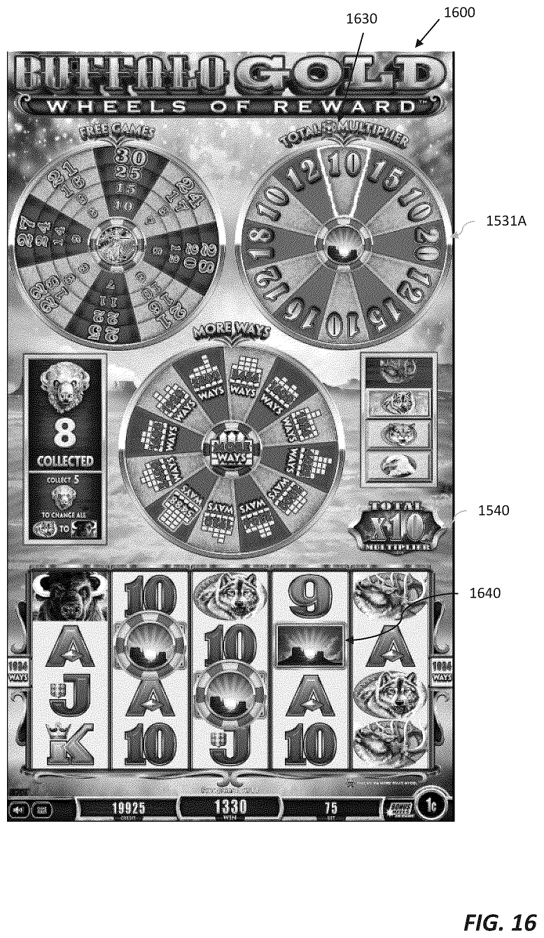

Processor 204 then proceeds to step 546 and evaluates symbols for winning outcomes before making an award for the game instance based on the winning outcomes and the wheel awards. In examples such as this one, where the wheel award doesn't interact with the winning outcomes, the award based on the awarded wheel prize and any winning outcomes is effectively two independent awards and, as such, the awards may be made separately. For example, the free games can be awarded immediately by processor 204 after step 542 and before evaluation of symbols for winning outcomes at step 546 as shown in the screen display of FIG. 13. However, in other examples (such as that shown in FIGS. 14 to 18), wheel awards will cause a modification of the awards made for winning outcomes.

In this respect, FIGS. 14 to 18 show an example of an award being made that includes an award of a multiplier from Multiplier Wheel 632 which interacts with winning outcomes for combinations of symbols.

FIG. 14 shows an example screen display 1400 where the symbols selected by the processor 204 included two SPECIAL WILD symbols 1451, 1452. Accordingly, in this game instance, at step 538 processor 204 determines that there is an award wheel trigger because the two SPECIAL WILD symbols exceed the threshold number of a defined symbol for an award of a selection of a multiplier from the Multiplier Wheel 632. In this example, the threshold number is one—i.e. one or more SPECIAL WILD symbols satisfy the Multiplier Wheel trigger condition.

The processor 204 determines which layer is to be used at step 540 (and hence which set of wheel awards are to be used) based on the number of defined symbols (assuming at least a threshold number have been selected for display). Then, at step 542 the processor 204 selects a wheel award from the determined set of wheel award using RNG 212 and a weight table stored in memory. In this example, each wheel award is an award of a multiplier. In this example the Multiplier Wheel has three layers of prizes: inner 632A, middle 632B, and outer 632C. The prizes shown are the total multipliers (not individual). The prizes/multipliers on the wheel are laid out in clockwise direction. In this example:

When 1 SPECIAL WILD symbol triggers the Multiplier Wheel 643, the prizes from the inner layer 632A will be available, and one of them will be awarded.

When 2 SPECIAL WILD symbol triggers the Multiplier Wheel 643, the prizes from the middle layer 632B will be available, and one of them will be awarded.

When 3 SPECIAL WILD symbol triggers the Multiplier Wheel 643, the prizes from the outer layer 632C will be available, and one of them will be awarded.

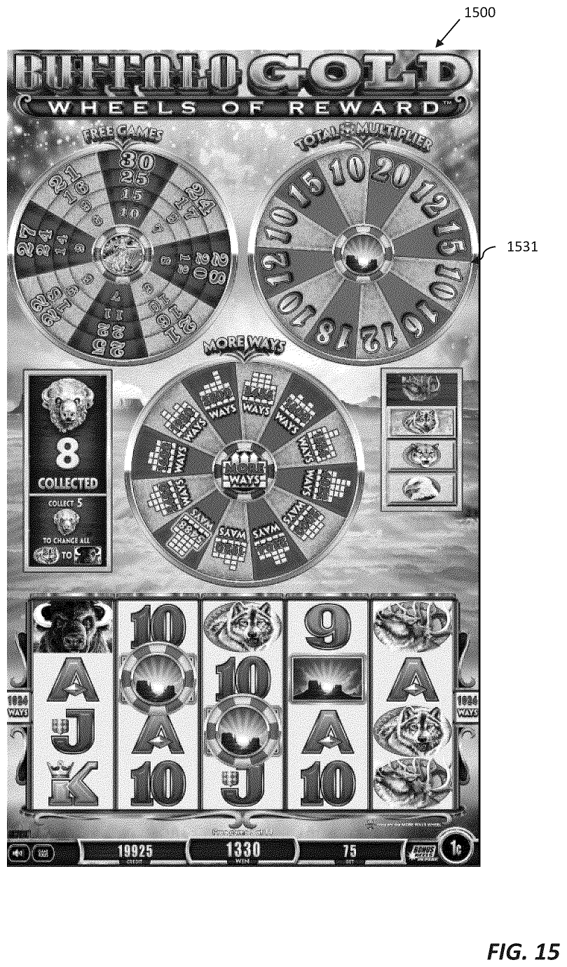

As described in relation to the Free Games Wheel 631 above, once a layer of Multiplier Wheel is selected at step 540, the display of the Multiplier Wheel is visually modified, in one example, the selected layer will be visually displayed to expand, covering the other two layers as shown by modified Multiplier Wheel 1531 in the example screen display 1500 of FIG. 15. In this example, processor 204 makes the selection using RNG 212 and a weight table in memory 208 from the prize awards associated with middle layer 633B. Modified Multiplier Wheel 1531 is shown in FIG. 15 in which only prizes of the selected layer are displayed (here the prizes displayed on the middle layer in FIG. 14). Processor 204 then controls the display 240 to visually display an animation of the modified Multiplier award wheel 1532 spinning to a stopped configuration 1531A relative to an award indicator 1630 to indicate an awarded wheel prize. In this example, a 10 times multiplier which is then displayed on total multiplier indicator 1540.

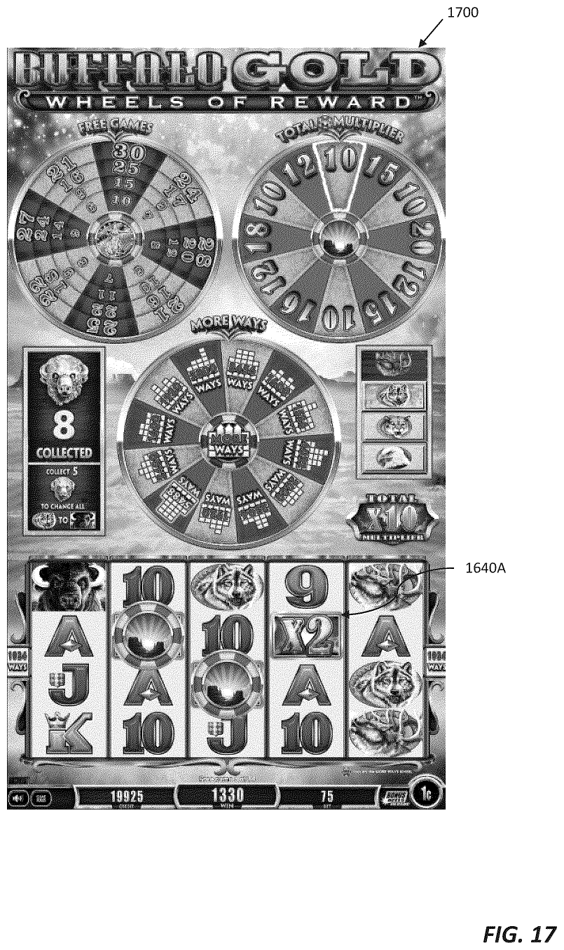

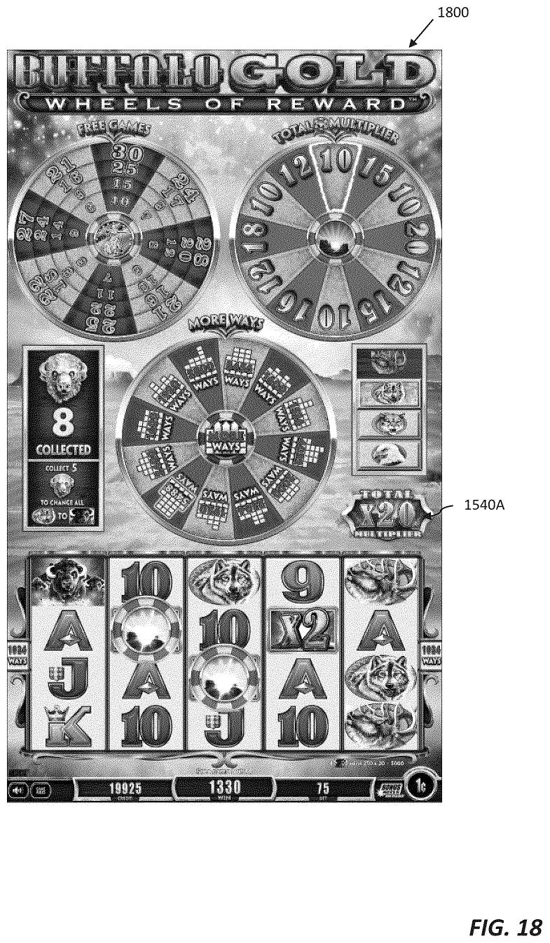

Processor 204 then proceeds to further evaluation of the displayed symbols which, in this example, includes making a random determination in respect of each displayed Wild symbol as to whether they will incorporate 1×, 2× or 3× multiplier. In this example, Wild symbol 1640 becomes a 2× multiplier as shown in screen display 1700 of FIG. 17 resulting in an adjusted total multiplier of ×20 as shown by modified multiplier indicator 1540A in screen display 800 of FIG. 18.

In this example, processor 204 then evaluates the winning outcomes at step 546 using a pay table in memory 208, processor 204 makes an award at step 548 based on the winning outcomes, the ×10 wheel award multiplier, and the ×2 wild multiplier. Thus, in this example, the multiplier that is awarded from Multiplier Wheel affects the total award made for the game instance.

### EXAMPLE EMBODIMENTS

In an example embodiment, there is disclosed a gaming device comprising:
a display;
a random number generator;
at least one input mechanism;
a processor; and
a memory storing (i) reel data defining a plurality of symbol reel strips, and an overlay reel strip comprising at least one designated symbol (ii) instructions which, when executed by the processor, cause the processor to:
control the display to display to display an initial number of symbol positions;
control the display to display an award wheel comprising a set of wheel awards, each wheel award corresponding to a modified number of symbol positions;
select, in response to receipt of a wager via the at least one input mechanism using the random number generator, stopping positions for the overlay reel strip and each of the symbol reel strips;
control the display to display symbols at the initial number of symbol positions based on the selected stopping positions of the symbol reel strips;
upon the selected stopping position of the overlay reel strip resulting in display of a designated symbol of the at least one designated symbol, make a wheel award from the award wheel by using the random number generator to select a wheel award of the plurality of wheel awards, control the display to display the modified number of symbol positions based on the wheel award, and control the display to display symbols at the modified number of symbol positions based on the selected stopping positions of the symbol reel strips;
evaluate the displayed symbols at the modified number of symbol positions for winning outcomes; and
make an award based on any winning outcomes.

In another example embodiment, there is disclosed a method of operating a gaming device a display, a random number generator, at least one input mechanism, a processor, and a memory storing reel data defining a plurality of reel strips, the method comprising:
controlling the display to display to display an initial number of symbol positions;
controlling the display to display an award wheel comprising a set of wheel awards, each wheel award corresponding to a modified number of symbol positions;
selecting, in response to receipt of a wager via the at least one input mechanism using the random number generator, stopping positions for the overlay reel strip and each of the symbol reel strips;
controlling the display to display symbols at the initial number of symbol positions based on the selected stopping positions of the symbol reel strips;
upon the selected stopping position of the overlay reel strip resulting in display of a designated symbol of the at least one designated symbol, making a wheel award from the award wheel by using the random number generator to select a wheel award of the plurality of wheel awards, controlling the display to display the modified number of symbol positions based on the wheel award, and controlling the display to display symbols at the modified number of symbol positions based on the selected stopping positions of the symbol reel strips;
evaluating the displayed symbols at the modified number of symbol positions for winning outcomes; and
making an award based on any winning outcomes.

In another example embodiment, there is disclosed a system comprising:
at least one display;
a random number generator;
at least one input mechanism;
one or more processors; and
a memory storing (i) reel data defining a plurality of reel strips, and (ii) instructions which, when executed by the one or more processors, cause the one or more processors to:
control the display to display to display an initial number of symbol positions;
control the display to display an award wheel comprising a set of wheel awards, each wheel award corresponding to a modified number of symbol positions;
select, in response to receipt of a wager via the at least one input mechanism using the random number generator, stopping positions for the overlay reel strip and each of the symbol reel strips;
control the display to display symbols at the initial number of symbol positions based on the selected stopping positions of the symbol reel strips;
upon the selected stopping position of the overlay reel strip resulting in display of a designated symbol of the at least one designated symbol, make a wheel award from the award wheel by using the random number generator to select a wheel award of the plurality of wheel awards, control the display to display the modified number of symbol positions based on the wheel award, and control the display to display symbols at the modified number of symbol positions based on the selected stopping positions of the symbol reel strips;
evaluate the displayed symbols at the modified number of symbol positions for winning outcomes; and
make an award based on any winning outcomes.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. A gaming device comprising:
a display;
a random number generator;
at least one input mechanism;
a processor; and
a memory storing (i) a reel strip data structure comprising reel data defining a plurality of reel strips, and (ii) instructions which, when executed by the processor, cause the processor to:
control the display to display at least one award wheel, the award wheel comprising a plurality of layers, each layer displaying a respective one of a plurality of different sets of wheel awards comprised in one or more wheel award data structures;
perform a selection operation using the random number generator and the reel strip data structure to obtain symbols from the plurality of reel strips for a plurality of symbol positions;
control the display to display the selected symbols at the symbol positions;
upon the selected symbols including at least a threshold number of a defined symbol:
determining a set of wheel awards to be used from the plurality of different sets of wheel awards displayed on the layers of the award wheel based on the number of the at least a threshold number of defined symbols, and
performing a wheel award selection operation using the random number generator, a wheel award of the determined set of wheel awards from the one or more wheel award data structures to obtain a selected wheel award;
determine an outcome based on the selected wheel award.

2. The gaming device as claimed in claim 1, wherein the threshold number is one.

3. The gaming device as claimed in claim 1, wherein the threshold number is two or more.

4. The gaming device of claim 1, wherein the instructions further cause the processor to, subsequent to determining a set of awards to be used from the plurality of different sets of wheel awards displayed on the layers of the award wheel, modify display of the award wheel to show the determined set of awards, and control the display to show the modified award wheel spinning to a stopped configuration relative to an award indicator that indicates the awarded wheel prize.

5. The gaming device of claim 4, wherein the instructions to modify display of the award wheel to show the determined set of awards comprises instructions to visually expand the layer comprising the set of awards to cover the remaining layers of the award wheel.

6. The gaming device of claim 1, wherein each of the wheel awards comprises a multiplier and wherein the instructions further cause the processor to multiply any winning outcomes by the multiplier of the selected wheel award.

7. The gaming device of claim 1, wherein each of the wheel awards comprises a number of free games and when the instructions further cause the processor to determine the outcome based on any winning outcomes and the number of free games of the selected wheel award.

8. A method of operating a gaming device comprising:
controlling the display to display at least one award wheel, the award wheel comprising a plurality of layers, each layer displaying a respective one of a plurality of different sets of wheel awards comprised in one or more wheel award data structures;
perform a selection operation using a random number generator and a reel strip data structure comprising reel data defining a plurality of reel strips, symbols from the reel strips for display at a plurality of symbol positions;
controlling the display to display the selected symbols at the symbol positions;
upon the selected symbols including at least a threshold number of a defined symbol:
determining a set of wheel awards to be used from the plurality of different sets of wheel awards displayed on the layers of the award wheel based on the number of the at least a threshold number of defined symbols, and
perform a wheel award selection operation using the random number generator, a wheel award from the determined set of wheel awards from the one or more wheel award data structures to obtain a selected wheel award; and
determining an outcome based on the selected wheel award and any winning outcomes.

9. The method as claimed in claim 8, wherein the threshold number is one.

10. The method as claimed in claim 8, wherein the threshold number is two or more.

11. The method of claim 8, comprising, subsequent to determining a set of awards to be used from the plurality of different sets of wheel awards displayed on the layers of the award wheel, modifying display of the award wheel to show the determined set of awards, and controlling the display to show the modified award wheel spinning to a stopped configuration relative to an award indicator that indicates the awarded wheel prize.

12. The method of claim 11, modifying display of the award wheel to show the determined set of awards comprises visually expanding the layer comprising the set of awards to cover the remaining layers of the award wheel.

13. The method of claim 8, wherein each of the wheel awards comprises a multiplier and making the award comprises multiplying any winning outcomes by the multiplier of the selected wheel award.

14. The method of claim 8, wherein each of the wheel awards comprises a number of free games and determining the outcome is based on any winning outcomes and the number of free games of the selected wheel award.

15. A non-transitory computer readable medium comprising computer readable code executable by one or more processors to:
perform a selection operation using a random number generator and a reel strip data structure comprising reel data defining a plurality of reel strips to obtain selected symbols from reel strips for display at a plurality of symbol positions;
upon the selected symbols including at least a threshold number of a defined symbol:
determine a set of wheel awards to be used from a plurality of different sets of wheel awards each corresponding to a layer of an award wheel based on the number of the at least a threshold number of defined symbols, and
perform a selection operation using the random number generator and a wheel award of the determined set of wheel awards from the one or more wheel award data structures to obtain a selected wheel award; and
determine an outcome based on the selected wheel award.

16. The non-transitory computer readable medium of claim 15, wherein the threshold number is one.

17. The non-transitory computer readable medium of claim 15, wherein the threshold number is two or more.

18. The non-transitory computer readable medium of claim 15, wherein the computer readable code further causes the one or more processor to, subsequent to determining a set of awards to be used from the plurality of different sets of wheel awards displayed on the layers of the award wheel, modify display of the award wheel to show the determined set of awards, and control the display to show the modified award wheel spinning to a stopped configuration relative to an award indicator that indicates the awarded wheel prize.

19. The non-transitory computer readable medium of claim 15, wherein each of the wheel awards comprises a multiplier and wherein the computer readable code further causes the one or more processors to multiply any winning outcomes by the multiplier of the selected wheel award.

20. The non-transitory computer readable medium of claim 15, wherein each of the wheel awards comprises a number of free games and when the computer readable code further causes the one or more processors to determine the outcome based on any winning outcomes and the number of free games of the selected wheel award.
